(19) United States
(12) Patent Application Publication
(10) Pub. No.: US 2024/0223835 A1
(43) Pub. Date: Jul. 4, 2024

(54) SYSTEM AND METHOD FOR CONTROLLED TRANSMISSION OF LEARNING MATERIAL FROM MOBILE PHONE TO ELECTRONIC DEVICE

(71) Applicants: Mayank KUMAR, Mumbai (IN); Akanksha BANSAL, Mumbai (IN); Nitin SHENOY, Navi Mumbai (IN)

(72) Inventors: Mayank KUMAR, Mumbai (IN); Akanksha BANSAL, Mumbai (IN); Nitin SHENOY, Navi Mumbai (IN)

(21) Appl. No.: 18/294,485

(22) PCT Filed: Jul. 1, 2022
(86) PCT No.: PCT/IB2022/056139

§ 371 Date: Feb. 1, 2024

(30) Foreign Application Priority Data
Jul. 2, 2021 (IN) 202121029886

(51) Int. Cl. H04N 21/41; H04N 21/2187; H04N 21/472

(52) U.S. Cl. CPC H04N 21/4122; H04N 21/2187; H04N 21/472

(57) ABSTRACT

A method, a system and an electronic device are disclosed herein for providing a controlled transmission of a content pack from a primary electronic device 104 to the electronic device being used by a child. The primary electronic device 104 is configured to operate, via a server 108 in a communication network 106, a content delivery module 110 for delivering at least one part of the content pack. The electronic device is configured to receive the at least one part of the content pack from the primary electronic device 104, wherein the at least one part of the content pack is pre-selected from the content pack by a user associated with the primary electronic device 104.

### TECHNICAL FIELD

The present subject matter in general relates to exchange of educational content between electronic devices. In particular, the present invention relates to a system and a method for controlled transmission of educational and entertainment content meant for kids from a primary electronic device to a secondary electronic device using Bluetooth/Wi-Fi/wired cable/near field communication (NFC)/other similar technology.

### BACKGROUND

Technology has changed learning and entertainment for all, including preschoolers and early learners. Various solutions are available in the art for kids learning, entertainment in the form of mobile-based applications or web-based applications (hereinafter ‘apps’), electronic learning devices and toys, electronic books, learning kits, E-readers etc. With the advent of software and electronic devices in learning and entertainment, kids tend to spend more time on screens than ever. Further, many times there are situations when an electronic device, such as a tablet, requires more unwanted or undesirable functions that requires special attention from parents. This is because most of the innovations in education technology are software led and learning & entertainment content are accessible only via dedicated apps on mobile phones and tablets, televisions, or over-the-top OTT services. Apart from these software solutions, there are few toys and devices in kids education technology space that have limited content and get repetitive after a point of time and hence, have a short usage span for kids.

New non-backlit display technologies are also available in the art which are easier on the eyes, e.g., E-ink readers, reflective LCD displays. However, these new technologies are more expensive than the traditional backlit LCD displays.

Therefore, there is a well felt need for a system and method, which can achieve all the criteria in the process of learning, knowledge, and growth in an easy and cost-effective manner, and which overcomes the afore mentioned and other related challenges.

### SUMMARY

In view of the above, it is an object of the present subject matter to provide a secondary electronic device for children, which can be controlled by a supervising person through a respective primary electronic device or primary electronic device.

It is another object of the present subject matter to provide the secondary electronic device with non-backlit display screen or LCD screen designed for kids with interactive educational content.

It is yet another object of the present subject matter to control transfer of data from the primary electronic device through Bluetooth/Wi-fi/wired cable/near field communication (NFC)/other similar technology to the secondary electronic device designed for kids.

It is yet another object of the present subject matter to configure the secondary electronic device as an educational toy as well as an educational device for schools and online learning.

It is yet another object of the present subject matter to bring learning and entertainment content in the same electronic device.

It is yet another object of the present subject matter to employ non-Backlit display technology, which is easier on the eyes, e.g., E-ink readers, reflective LCD displays etc., as well as LCD screens in the learning device for kids.

It is yet another object of the present subject matter to provide the secondary electronic device as a learning device that is designed solely for kids by using eye-friendly displays and with interactive content designed specifically for kids, not limited to the on-board device memory.

It is yet another object of the present subject matter to provide the secondary electronic device as a learning device for early learners and that acts as an extended display for content resting on mobile phone applications.

It is yet another object of the present subject matter to provide different modes of communication between the primary and the secondary electronic devices by using Bluetooth, Wi-Fi, near field communication (NFC) etcetera.

It is yet another object of the present subject matter to provide different screen technologies like E-ink, Reflective LCD, traditional backlit LCD, touchscreen display etc. in an electronic device for kids.

It is yet another object of the present subject matter to reduce the harmful effects of screen time and mobile radiations to which a user is exposed.

It is yet another object of the present subject matter to provide content not limited to device memory that grows with the age of the kid.

According to an embodiment of the present disclosure, a method is disclosed for providing a controlled transmission of a content pack from a primary electronic device to a secondary electronic device. The method comprises: configuring the primary electronic device to operate, via a server in a communication network, a content delivery module for delivering at least one part of the content pack; configuring the secondary electronic device to receive the at least one part of the content pack from the primary electronic device, the secondary electronic device being communicably connected to the primary electronic device; wherein the at least one part of the content pack is pre-selected from the content pack by a user associated with the primary electronic device.

According to an embodiment of the present disclosure, the secondary electronic device is provided with an eye-friendly display screen, a memory, a microcontroller, and an interactive user interface to access the at least one part of the content pack.

According to an embodiment of the present disclosure, the content delivery module is operated on the primary electronic device to facilitate the associated user to pre-select the at least one part of the content pack.

According to an embodiment of the present disclosure, the content delivery module is operated by the user in a plurality of operating modes including solo mode 3 paired mode, and classroom mode.

According to an embodiment of the present disclosure, the solo mode is operated by the primary electronic device to upload the at least one part of the content pack on the secondary electronic device to thereby facilitate a child associated with the secondary electronic device, to independently access the uploaded at least one part of the content pack.

According to an embodiment of the present disclosure, the paired mode is operated by the primary electronic device to communicate with the secondary electronic device in real time for thereby facilitating the secondary electronic device to access any part of the content pack via the primary electronic device.

According to an embodiment of the present disclosure, the classroom mode is operated by the primary electronic device to facilitate establishment of a remote connection between the secondary electronic device and a remote device for thereby facilitating the secondary electronic device to access one or more online educational sessions conducted by the remote device.

According to an embodiment of the present disclosure, the content pack is stored in a memory associated with the primary electronic device.

According to an embodiment of the present disclosure, a system is disclosed for providing a controlled transmission of a content pack from a primary electronic device to a secondary electronic device. The system comprises the primary electronic device configured to operate, via a server in a communication network, a content delivery module for delivering at least one part of the content pack; the secondary electronic device configured to receive the at least one part of the content pack from the primary electronic device, the secondary electronic device being communicably connected to the primary electronic device; wherein the at least one part of the content pack is pre-selected from the content pack by a user associated with the primary electronic device.

According to an embodiment of the present disclosure, an electronic device is disclosed. The electronic device comprises an input unit; a processing unit; and an output unit; wherein the processing unit is configured to: receive at least one part of a content pack stored in a primary electronic device, the received at least one part of the content pack being pre-selected by the primary electronic device upon operating a content delivery module, and facilitate a child associated with the electronic device to access the received at least one part of a content pack in an interactive manner by using the input unit and the output unit.

According to an embodiment of the present disclosure, the output unit comprises an eye-friendly display screen to display the at least one part of the content pack.

According to an embodiment of the present disclosure, the output unit comprises one or more in-built audio speakers with volume control buttons, and a port to connect an external speaker.

According to an embodiment of the present disclosure, the input unit includes keypads, buttons, touchpads, touchscreen, microphone, camera, and fingerprint sensor.

According to an embodiment of the present disclosure, the electronic device further comprises a detachable doodle board or any other writing apparatus, keyboard, counting devices like abacus.

The afore-mentioned objectives and additional aspects of the embodiments herein will be better understood when read in conjunction with the following description and accompanying drawings. It should be understood, however, that the following descriptions, while indicating preferred embodiments and numerous specific details thereof, are given by way of illustration and not of limitation. This section is intended only to introduce certain objects and aspects of the present invention, and is therefore, not intended to define key features or scope of the subject matter of the present invention.

### BRIEF DESCRIPTION OF ACCOMPANYING DRAWINGS

The present invention, both as to its organization and manner of operation, together with further objects and advantages, may best be understood by reference to the following description, taken in connection with the accompanying drawings. These and other details of the present invention will be described in connection with the accompanying drawings, which are furnished only by way of illustration and not in limitation of the invention, and in which drawings:

FIG. 1 illustrates a system for providing controlled transmission of a content pack from a primary electronic device to a secondary electronic device, in accordance with one embodiment of the present subject matter.

FIG. 2A illustrates a front view of an electronic device that may be configured as a secondary electronic device, in accordance with one embodiment of the present subject matter.

FIG. 2B shows various functional components of the electronic device 102 in a preferred embodiment.

FIG. 2C shows various contents that can be transmitted to the electronic device 102 for the kids.

FIG. 3 depicts various modes of the system, in accordance with one embodiment of the present subject matter.

FIG. 4 is a block diagram illustrating various components of the system, according to an embodiment of the present subject matter.

FIG. 5 is a flow diagram illustrating various steps involved in a method for providing controlled transmission of a content pack from a primary electronic device to a secondary electronic device, according to an embodiment of the present subject matter.

Like reference numerals refer to like parts throughout the description of several views of the drawings.

### DETAILED DESCRIPTION

The following presents a detailed description of various embodiments of the present subject matter with reference to the accompanying drawings.

The embodiments of the present subject matter are described in detail with reference to the accompanying drawings. However, the present subject matter is not limited to these embodiments which are only provided to explain more clearly the present subject matter to a person skilled in the art of the present disclosure. In the accompanying drawings, like reference numerals are used to indicate like components.

The specification may refer to “an”, “one”, “different” or “some” embodiment(s) in several locations. This does not necessarily imply that each such reference is to the same embodiment(s), or that the feature only applies to a single embodiment. Single features of different embodiments may also be combined to provide other embodiments.

As used herein, the singular forms “a”, “an” and “the” are intended to include the plural forms as well, unless expressly stated otherwise. It will be further understood that the terms “includes”, “comprises”, “including” and/or “comprising” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “attached” or “connected” or “coupled” or “mounted” to another element, it can be directly attached or connected or coupled to the other element or intervening elements may be present. As used herein, the term “and/or” includes all combinations and arrangements of one or more of the associated listed items.

The figures depict a simplified structure only showing some elements and functional entities, all being logical units whose implementation may differ from what is shown.

The subject matter discloses herein a controlled transmission of a content pack from a primary electronic device to the electronic device or a secondary electronic device being used by a child. The primary electronic device is configured to operate, via a server in a communication network, a content delivery module for delivering at least one part of the content pack. The electronic device is configured to receive the at least one part of the content pack from the primary electronic device, wherein the at least one part of the content pack is pre-selected from the content pack by a user associated with the primary electronic device.

As used herein, ‘server’ is a computer-based device or a system that facilitates in providing, data, services, or programs to various client devices over a communication network 106. The server may include one or more intelligent processing devices or modules, capable of processing digital logics and also possesses analytical skills for analyzing and processing various data or information, according to the embodiments of the present invention.

As used herein, ‘primary electronic device’ is a smart electronic device capable of communicating with various other electronic devices and applications via one or more communication network 106s. Examples of said primary electronic device include, but not limited to, a wireless communication device, a smart phone, a tablet, a desktop, a laptop, etcetera. The primary electronic device comprises: an input unit to receive one or more input data; an operating system to enable the primary electronic device/electronic device to operate; a processing to process various data and information; a memory unit to store initial data, intermediary data and final data; and an output unit having a graphical user interface (GUI).

As used herein, ‘storage device’ refers to a local or remote storage device; docket systems; database systems; capable to store information related to transmission of educational content, audio-visual content, play list, user profiles, historical data, etcetera. In an embodiment, the storage device may be a database server, a cloud storage, a remote database, a local database, a storage unit.

As used herein, ‘module’ or ‘unit’ refers to a device, a system, a hardware, a computer application configured to execute specific functions or instructions according to the embodiments of the present invention. The module or unit may include a single device or multiple devices configured to perform specific functions according to the present invention disclosed herein.

As used herein, ‘communication network 106’ includes a local area network (LAN), a wide area network (WAN), a metropolitan area network (MAN), a virtual private network (VPN), an enterprise private network (EPN), Internet, and a global area network (GAN).

Terms such as ‘connect’, ‘integrate’, ‘configure’, and other similar terms include a physical connection, a wireless connection, a logical connection, or a combination of such connections including electrical, optical, RF, infrared, Bluetooth, or other transmission media, and include configuration of software applications to execute computer program instructions, as specific to the presently disclosed embodiments, or as may be obvious to a person skilled in the art.

Terms such as ‘send’, ‘transfer’, ‘transmit’ and ‘receive’, ‘collect’, ‘obtain’, ‘access’ and other similar terms refers to transmission of data between various modules and units via wired or wireless connections across a communication network.

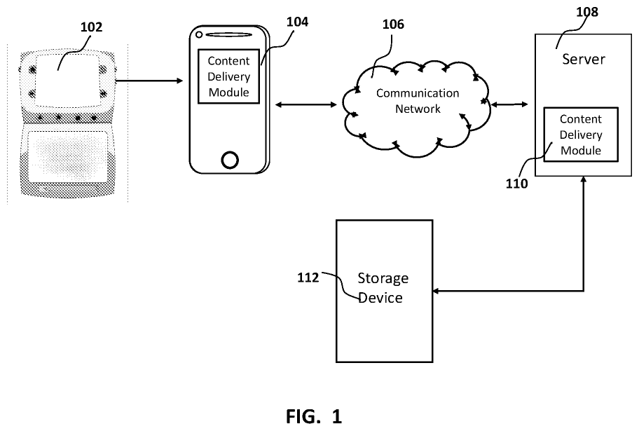

FIG. 1 illustrates a system for providing controlled transmission of a content pack from a primary electronic device 104 to a secondary electronic device 102, in accordance with one embodiment of the present subject matter. The system comprises a server 108, a primary electronic device 104, a secondary electronic device 102, and a storage device 112 communicably connected to each other across a communication network 106. An executable content delivery module 110 may be configured on the server 108. The primary electronic device 104 may be configured to operate the content delivery module 110 via the server 108. The content delivery module 110 may be configured on the primary electronic device 104 by following download instructions by respective registered users associated with the primary electronic device 104. The primary electronic device 104 is provided with unlimited access to all parts of the content pack stored therein. The primary electronic device 104 can be used by parents, teachers or supervisors of kids or students. The secondary electronic device 102 is provided with limited access to selected parts of the content pack as decided by the user of the primary electronic device 104. The secondary electronic device 102 is designed and configured to be used by kids or students.

The content delivery module 110 is configured for delivering at least one part of the content pack from a primary electronic device 104 to a secondary electronic device 102. The secondary electronic device 102 is configured to receive the at least one part of the content pack from the primary electronic device 104. The secondary electronic device 102 may be communicably connected to the primary electronic device 104, wherein the at least one part of the content pack is pre-selected from the content pack by a user associated with the primary electronic device 104. The secondary electronic device 102 is provided with an eye-friendly display screen, a memory, a microcontroller, speakers, and an interactive user interface to access the at least one part of the content pack.

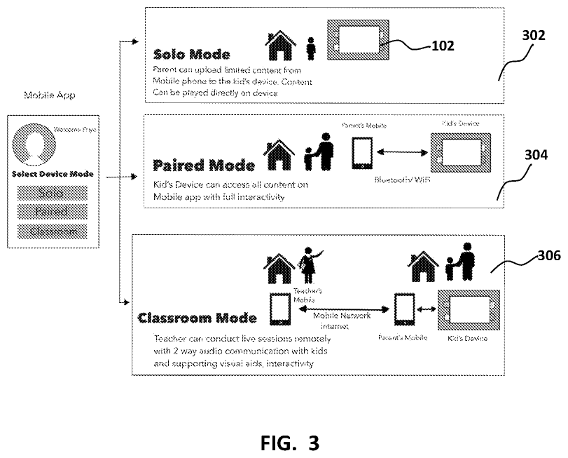

According to an embodiment of the present disclosure, the content delivery module 110 is operated on the primary electronic device 104 to facilitate the associated user to pre-select the at least one part of the content pack. Further, the content delivery module 110 is operated by the user in a plurality of operating modes including solo mode, paired mode, and classroom mode. The various modes of operation are shown in FIG. 3.

The content pack and the data pertaining to the content delivery may be stored in the memories of the primary electronic device 104 or any storage device 112s which may be accessed by the primary electronic device 104 via the server 108. The users or the supervisors of the kids may register their profiles with the content delivery module 110. The content delivery module 110 may be configured for assisting the user to select the type of content suitable for respective kids according to their choices and preferences. The selected content may be displayed to the child via the graphical user interface on the display screen of the secondary electronic device 102. The data pertaining to the educational content pack delivery is exchanged between the primary electronic device 104 and the secondary electronic device 102 through data transfer modules such as Bluetooth/WiFi/wired cable/near field communication (NFC)/other similar technologies.

According to the embodiments of the present invention, the content pack may include educational content for children such as, stories, poetries, rhymes, interactive puzzles, games, audio-visual e-book content etcetera.

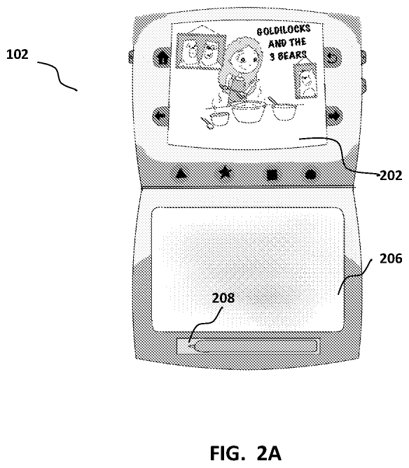

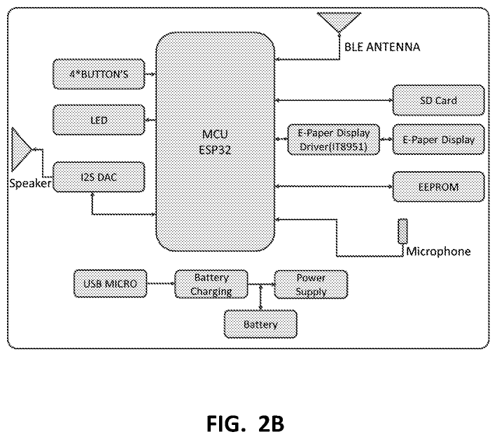

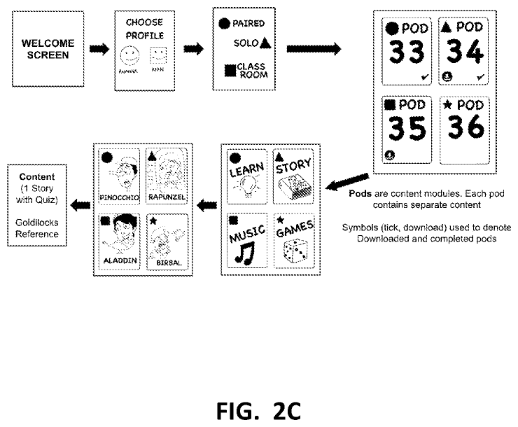

FIG. 2A illustrates a front view of the electronic device 102, in accordance with one embodiment of the present subject matter. The electronic device 102 is an educational handheld toy device that can be configured to be used by kids as the ‘secondary electronic device 102’ at home and can also be configured for schools and online learning platforms. The electronic device 102 comprises an input unit, a processing unit, and an output unit. The processing unit is configured to receive at least one part of a content pack stored in a primary electronic device 104. The received at least one part of the content pack being pre-selected by the primary electronic device 104 upon operating a content delivery module 110, and facilitate a child associated with the electronic device or the secondary electronic device 102, to access the received at least one part of a content pack in an interactive manner by using the input unit and the output unit. The output unit comprises an eye-friendly display screen 202 to display the at least one part of the content pack. The eye-friendly display screen 202 includes a non-backlit display screen designed for the kids and displays interactive educational content. The output unit further comprises one or more in-built audio speakers with volume control buttons, and a port to connect an external speaker.

FIG. 2B shows various functional components of the electronic device 102 in a preferred embodiment. The various components include a plurality of buttons, LEDs, e-paper display, e-paper display driver, SD card, EEPROM, USB Micro, battery, battery charging port, power supply, microphone antenna, speaker etcetera. According to an embodiment, the input unit includes keypads, buttons, touchpads, touchscreen, microphone, camera, and fingerprint sensor. Preferably, there may be eight buttons provided in the electronic device 102. The electronic device 102 further comprises a writing hardware and modules such as a detachable doodle board 206 with a writing pen 208 or any writing board to enable a child to scribble and doodle while learning and playing with the electronic device 102. The writing hardware 206 is configured to teach and encourage the kids to do daily writing in a fun and interactive way.

FIG. 2C shows various contents that can be transmitted to the electronic device 102 for the kids. As shown in the figure, a plurality of audio-visual content including story e-book, puzzles, general knowledge content, rhymes, content pertaining to various languages, academic related content etcetera, may be provided for stimulating imagination and encourage reading. The doodling board helps the kids to practice writing and drawing while learning and can be detached when not in use. Thus, it becomes very handy for use by the kids. The doodling board also includes learning modules, which are designed for the user to learn and practice writing on the given doodling board as an attachment without providing any external guidance. This helps a user in grasping things easily and more efficiently. The electronic device 102 therefore can be used by the kids as an alternate to TV/Mobile to keep them engaged in a progressive manner.

The electronic device 102 is thus a learning device for early learners and can also be used as an extended display or secondary electronic display device for displaying the content stored on the primary electronic devices 104. In an embodiment, the electronic device 102 uses reflective display technologies, like E-ink, non-backlit LCD etc., instead of the commonly available, cheaper backlit LCDs. To keep the costs in check, the electronic device of the present invention is configured as an extended display along with a mobile phone or laptop, which serves as the content source/processing unit for the secondary device. Thus, the cost of the electronic device 102 is relatively lesser than other electronic toys that use dedicated processors. Moreover, the electronic device according to the present invention requires limited internet connectivity to operate.

In an embodiment, content not limited to device memory may be streamed from the content delivery module 110 to the electronic device 102, without being restricted by the memory space present in the electronic device 102. A value-for-money learning tool is thus provided by the electronic device 102 that may be updated from time to time to accommodate the learning requirements of growing kids. In a preferred embodiment, the electronic device 102 is an independent device for kids with ad-free and kid safe content, yet controlled by parents, thereby allowing free up time for adults by offering independent playtime.

In a preferred embodiment, the electronic device is a tablet like device having display screen 202 and power button on one side, and volume button on the other side of the screen. The electronic device 102 may also be provided with in-built speakers for better audio and visual experience of learning for kids. The microphone enables the user to make a two-way communication, especially in the ‘classroom’ mode.

In one embodiment, the electronic device 102 is used as a learning apparatus via a display screen wherein the content is provided for the early learners. The display screen of the learning tablet acts as an extended display for content resting on mobile application. The extended display serves as the source or process from the mobile phone. In a preferred embodiment, the display technology uses a non-backlit LCD, which is sensitive for the eyes of the kids, modules configured to encourage the writing, audio-visual story e-books that stimulate the imagination and encourage reading.

FIG. 3 depicts various modes of the system, in accordance with one embodiment of the present subject matter. According to an embodiment of the present disclosure, the content delivery module 110 is operated by the user in a plurality of operating modes including solo mode 302, paired mode 304, and classroom mode 306. The solo mode 302 is operated by the primary electronic device 104 to upload the at least one part of the content pack on the secondary electronic device 102 to thereby facilitate a child associated with the secondary electronic device 102, to independently access the uploaded at least one part of the content pack. In the solo mode 302 in an embodiment, parents or supervisors of the kids are facilitated to upload limited content from their devices such as mobile phones, to the secondary electronic device 102. The uploaded content can subsequently be played directly on said electronic device by the kid. The solo mode 302 provides access to limited content downloaded on the electronic device. In this mode, the user can add/delete content within the defined memory available on the secondary electronic device 102.

The paired mode 304 is operated by the primary electronic device 104 to communicate with the secondary electronic device 102 in real time for thereby facilitating the secondary electronic device 102 to access any part of the content pack via the primary electronic device 104. In the paired mode 304, the secondary electronic device 102 is connected to the content delivery module 110 as an extended display device and is configured to access desired content with full interactivity. All content hosted on the primary electronic device 104 is accessible by the secondary electronic device 102 via the content delivery module 110.

Further, the classroom mode 306 is operated by the primary electronic device 104 to facilitate establishment of a remote connection between the secondary electronic device 102 and a remote device for thereby facilitating the secondary electronic device 102 to access one or more online educational sessions conducted by the remote device. In the classroom mode 306, the electronic device allows for live sessions remotely hosted by teachers/parents/supervisors. In an embodiment, a teacher can conduct live sessions remotely with two-way audio communication between a remote device, such as mobile phone or laptop of the teacher, and kids' secondary electronic device 102 in the classroom mode 306. In this mode, supporting visual aids may be provided. The live classroom mode 306 306 enables the teachers to share content and interact with the students on the electronic device.

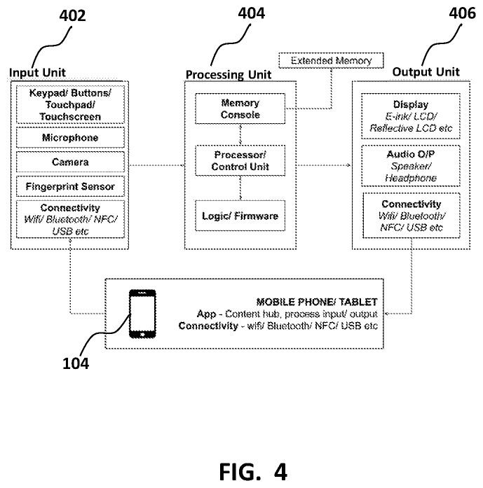

FIG. 4 illustrates a block diagram of the system depicting its electronic components according to an embodiment of the present subject matter. As shown herein, the system comprises an input unit 402, a processing unit 404 and an output unit 406. In an embodiment, the input unit 402 comprises one or more of a keypad comprising a plurality of action buttons, a touchpad, a touch screen, a microphone, a camera, a fingerprint sensor and so on. The action buttons are configured to take input as indicated on the displayed content. The action buttons include but are not limited to a ‘Home’ button for taking the user back to ‘Home screen’, ‘Play/Pause’ button, ‘Enter/Submit’ button to submit answer(s) selected through the action buttons, and ‘Up/Down’ button to scroll up and down. In an embodiment, the touchpad enables the user to interact directly with what is displayed on the electronic device.

In an embodiment, secured login may be provided by implementing fingerprint sensors on the secondary electronic device 102, that enable the kids to unlock the respective devices. In another embodiment, the camera enables the user to access/unlock the secondary electronic device 102 via face recognition features. In yet another embodiment, the camera is also configured to click HD pictures and store these pictures on the in-built memory of the secondary electronic device 102. The connectivity (WIFI/Bluetooth) console enables establishment of two-way communication between the secondary electronic device 102 and the primary devices such as mobile phones, laptops or tablets. In a preferred embodiment, data packets are transmitted between the secondary electronic device 102 and the primary device 104 by using wired and/or wireless mediums such as radio waves, Wi-Fi, Bluetooth, data cable etcetera.

In an embodiment, the processing unit 404, also referred to as a central unit, comprises but is not limited to a memory console, a microcontroller or control unit, a logic/firmware and a battery console. The memory console is configured to store all the data received from the microcontroller. In another embodiment, the memory console is also configured to store computer applications. The memory may include program modules, such as routines, programs, objects, components, data structures and so on, which perform tasks to be executed by the microcontroller. The memory device may be a general storage device 112 in an embodiment while in another embodiment, the memory device may be a specially configured, network enabled, solid state drive. In an embodiment, an extended memory may be provided in addition to or in an alternative to the memory device of the present system.

In an embodiment, the microcontroller is configured to process data received from the input unit 402 and convert all the input actions into audio and visuals on the display screen of the secondary electronic device 102 with the help of in-built firmware. Any input action is registered by the microcontroller and stored in the internal memory of the secondary electronic device 102 in a preferred embodiment. The microcontroller in accordance with one embodiment of the present subject matter may include a logic circuitry for processing instructions.

In an embodiment, logic/firmware console comprises an operating system and all the software programs related to the functioning of the secondary electronic device 102. The logic/firmware console is configured to provide hardware/processing unit 404 with the instructions for it to execute and working of the secondary electronic device 102 displaying of the content. In an embodiment, the battery console is configured to supply power to the secondary electronic device 102 including all the hardware.

In an embodiment, the output unit 406 comprises but is not limited to a display console, one or more audio units or speakers and connectivity console for connecting the secondary electronic device 102 with the mobile phone/tablet. In a preferred embodiment, the display console comprises E-ink, LCD, Reflective LCD, etc. The display console is configured to display the visual content as received from the internal microcontroller on the secondary electronic device 102. In an embodiment, the audio unit/speakers are configured to enable users to access various sounds and speech as stored in the memory console for learning purposes. In an embodiment, the connectivity console is configured to connect the secondary electronic device 102 with the mobile phone/tablet through WiFi, Bluetooth, NFC, USB and the like. In a preferred embodiment, the connectivity console of the input unit 402 and the output unit 406 comprises a single connectivity console. In another embodiment, separate connectivity consoles may be provided for the input unit 402 and the output unit 406 of the secondary electronic device 102. In an embodiment, the mobile phone/tablet can be configured to contain content hub and process input/output for transmitting the learning material to the secondary electronic device 102.

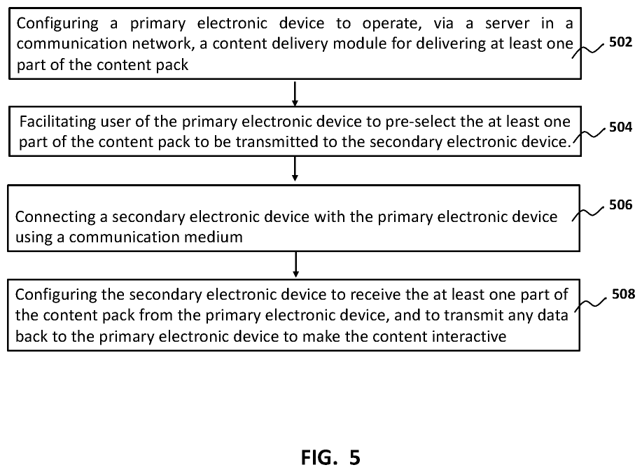

FIG. 5 is a flow diagram illustrating various steps involved in a method for providing controlled transmission of a content pack from a primary electronic device 104 to an electronic device, according to an embodiment of the present subject matter.

At step 502, a primary electronic device 104 may be configured to operate a content delivery module 110 for delivering at least one part of the content pack. The content pack is stored in a memory associated with the primary electronic device 104. The primary electronic device 104 is connected to a server 108 in a communication network 106 for operating the content delivery module 110. the content delivery module 110 is a mobile application or web application that facilitates the user of a primary device to execute controlled transmission of content data while sending the required data to a secondary device.

At step 504, user of the primary electronic device 104 is facilitated to pre-select the at least one part of the content pack to be transmitted to the secondary electronic device 102. The content delivery module 110 is operated on the primary electronic device 104 to facilitate the associated user to pre-select the at least one part of the content pack. The secondary electronic device 102 according to a preferred embodiment comprises a kid-friendly/eye-friendly screen, which is not harmful on the eyes of kids. In an embodiment, the device comprises reflective display technologies, like E-ink, non-backlit LCD, traditional LCD with or without touchscreen to ensure that kids eyes are not harmed in an event the screen time exceeds. The secondary electronic device 102 is provided with input unit 402, output unit 406, processing unit 404, a memory, a microcontroller, and an interactive user interface to access the at least one part of the content pack.

At step 506, the secondary electronic device 102 is connected to the primary electronic device 104 using a communication medium. The secondary electronic device 102 is connected to the primary electronic device 104 to receive at least one part of the content pack including audio-visual content, educational content etcetera. The primary electronic device 104 executes the content delivery module 110 to create content playlists which a child can navigate on the secondary electronic device 102. The input 402 and output unit 406 provided with the secondary electronic device 102, facilitates a child to accept choices, feed answers, navigate content, perform activities and tasks as indicated by the content being received and displayed to the child. This further facilitates in keeping the primary electronic device 104 free for other uses.

At step 508, configuring the secondary electronic device 102 to receive the at least one part of the content pack from the primary electronic device 104. The secondary electronic device can also transmit data back to the primary electronic device to make the content interactive. The content delivery module 110 is operated by the user in a plurality of operating modes including solo mode, paired mode, and classroom mode as illustrated in FIG. 3.

Thus, the present subject matter addresses the limitations of kids' toys and/or devices that are currently available in the market by providing features such as eye-friendly display suitable for kids' eyes. Unlike the prior existing solutions, the system, and method as disclosed herein, provide multiple features including content not limited to device memory for the kids' in a controlled manner, complete parental control. Further, the secondary device is a cost-effective device as most of the data processing is outsourced to a parent's/guardian's device and hence does not require costly components, for example high speed processors.

While the preferred embodiments of the present invention have been described hereinabove, various changes, adaptations, and modifications may be made therein without departing from the spirit of the invention and the scope of the appended claims. It will be obvious to a person skilled in the art that the present invention may be embodied in other specific forms without departing from its spirit or essential characteristics. The described embodiments are to be considered in all respects only as illustrative and not restrictive.

1. A method for providing controlled transmission of a content pack from a primary electronic device to a secondary electronic device, the method comprising:
configuring the primary electronic device to operate, via a server in a communication network, a content delivery module for delivering at least one part of the content pack; and
configuring the secondary electronic device to receive the at least one part of the content pack from the primary electronic device, the secondary electronic device being communicably connected to the primary electronic device;
the at least one part of the content pack being pre-selected from the content pack by a user associated with the primary electronic device.

2. The method of claim 1, wherein the secondary electronic device is provided with an eye-friendly display screen, a memory, a microcontroller, and an interactive user interface to access at least one part of the content pack.

3. The method of claim 1, wherein the content delivery module is operated on the primary electronic device to facilitate the user associated user to pre-select at least one part of the content pack.

4. The method of claim 1, wherein the content delivery module is operated by the user in a plurality of operating modes including solo mode, paired mode, and classroom mode.

5. The method of claim 4, wherein the solo mode is operated by the primary electronic device to upload the at least one part of the content pack on the secondary electronic device to thereby facilitate a child associated with the secondary electronic device, to independently access the uploaded at least one part of the content pack.

6. The method of claim 4, wherein the paired mode is operated by the primary electronic device to communicate with the secondary electronic device in real time for thereby facilitating the secondary electronic device to access any part of the content pack via the primary electronic device.

7. The method of claim 4, wherein the classroom mode is operated by the primary electronic device to facilitate establishment of a remote connection between the secondary electronic device and a remote device for thereby facilitating the secondary electronic device to access one or more live sessions conducted by the remote device.

8. The method of claim 1, wherein the content pack is stored in a memory associated with the primary electronic device.

9. A system for providing a controlled transmission of a content pack from a primary electronic device to a secondary electronic device, the system comprising:
the primary electronic device configured to operate, via a server in a communication network, a content delivery module for delivering at least one part of the content pack; and
the secondary electronic device configured to receive the at least one part of the content pack from the primary electronic device, the secondary electronic device being communicably connected to the primary electronic device;
the at least one part of the content pack being pre-selected from the content pack by a user associated with the primary electronic device.

10. The system of claim 9, wherein the secondary electronic device is provided with an eye-friendly display screen, a memory, a microcontroller, and an interactive user interface to access the at least one part of the content pack.

11. The system of claim 9, wherein the content delivery module is operated on the primary electronic device to facilitate the user associated to pre-select the at least one part of the content pack.

12. The system of claim 9, wherein the content delivery module is operated by the user in a plurality of operating modes including solo mode, paired mode, and classroom mode.

13. The system of claim 12, wherein the solo mode is operated by the primary electronic device to upload the at least one part of the content pack on the secondary electronic device to thereby facilitate a child associated with the secondary electronic device, to independently access the uploaded at least one part of the content pack.

14. The system of claim 12, wherein the paired mode is operated by the primary electronic device to communicate with the secondary electronic device in real time for thereby facilitating the secondary electronic device to access any part of the content pack via the primary electronic device.

15. The system of claim 12, wherein the classroom mode is operated by the primary electronic device to facilitate establishment of a remote connection between the secondary electronic device and a remote device for thereby facilitating the secondary electronic device to access one or more online educational sessions conducted by the remote device.

16. The system of claim 9, wherein the content pack is stored in a memory associated with the primary electronic device.

17. An electronic device comprising:
an input unit;
a processing unit; and
an output unit;
the processing unit being configured to:
receive at least one part of a content pack stored in a primary electronic device, the received at least one part of the content pack being pre-selected by the primary electronic device upon operating a content delivery module, and
facilitate a child associated with the electronic device to access the received at least one part of a content pack in an interactive manner by using the input unit and the output unit.

18. The electronic device of claim 17, wherein the output unit comprises an eye-friendly display screen to display the at least one part of the content pack.

19. The electronic device of claim 17, wherein the output unit comprises one or more in-built audio speakers with volume control buttons, and a port to connect an external speaker.

20. The electronic device of claim 17, wherein the input unit includes keypads, buttons, touchpads, touchscreen, microphone, camera, and fingerprint sensor.

21. The electronic device of claim 17, further comprises a detachable doodle board.
